(19) United States
(12) Patent Application Publication
(10) Pub. No.: US 2017/0173641 A1
(43) Pub. Date: Jun. 22, 2017

(54) REMOVAL OF SURFACING MATERIALS BY WET BLASTING

(71) Applicant: E-LOGIC INC., Southlake, TX (US)

(72) Inventors: Charles Dayton Oneal, Bridgeport, TX (US); John Michael Childress, Colleyville, TX (US)

(21) Appl. No.: 14/971,951

(22) Filed: Dec. 16, 2015

(51) Int. Cl. B08B 3/02; B24C 7/00; B24C 11/00; B08B 3/10; B24C 1/00

(52) U.S. Cl. CPC B08B 3/02; B08B 3/10; B24C 1/00; B24C 11/005; B24C 7/0007; B08B 2203/02; B08B 2220/00

(57) ABSTRACT

Provided herein are a system and method for an efficient and safe method for the removal of surfacing materials which may contain toxic components from a work surface through wet blasting. The method and apparatus provided may utilize a mixture of surfactant and water combined with abrasive media for use in a wet blasting operation in which the creation of waste in solid dust form is reduced or substantially prevented.

### BACKGROUND

Field of the Invention

This application is directed, in general, to blasting systems and, more specifically, to systems and methods for removing surfacing materials from a work surface through wet blasting.

Description of the Related Art

Certain building materials contain toxic materials which are harmful to people, such as asbestos or lead, for example. Inhalation of asbestos fibers, in particular, has been found to cause lung cancer, mesothelioma, and asbestosis. Unfortunately, before building materials containing asbestos, lead, and the like were found to be toxic, those materials were widely used throughout the construction industry in a multitude of surfacing materials and insulating materials. Surfacing materials may comprise building materials which may be sprayed, troweled, or otherwise applied to a surface of a structural component of a construction. More specifically, surfacing materials may comprise: paints; insulation; fireproofing materials; acoustic or texturing materials; spackling; compounds for patching and/or taping; adhesives; plasters; roofing materials; and the like. These surfacing materials are applied to various structural components of a construction, such as pipes, fittings, boilers, breeching, tanks, ducts, walls, floors, ceilings, and the like. Hereinafter these structural components may be referred to, collectively, as “works.” Further, hereinafter, the external surfaces of works to which surfacing materials may be applied may be referred to, collectively, as “work surfaces.”

The renovation, or demolition, of constructions built with toxic surfacing materials has become particularly problematic for builders and property developers. Oftentimes, these toxic surfacing materials must be removed from a construction and disposed of before any further renovation or demolition activities on the construction may be performed. Further, the removal and disposal of toxic surfacing materials are heavily regulated to ensure the safety of persons working in and near the work area in which such activities are performed by limiting the exposure of such persons to the toxic surfacing materials.

For removal of non-toxic surfacing materials, those which may not contain asbestos, lead, and the like, the fastest and most cost-effective removal method is dry abrasive blasting of the work surfaces. Dry abrasive blasting typically involves propelling a mix of abrasive and compressed air against a work surface to remove the surfacing materials. While dry abrasive blasting may be faster and cheaper than other known removal methods, dry abrasive blasting operations produce large amounts of airborne waste in the form of dust due to the abundance of friable material present in a dry environment. Friable materials may be those materials which can be crumbled, pulverized, or reduced to powder by hand pressure when dry, and may include the toxic surfacing material, itself, as well as certain abrasives which may be used as part of the dry abrasive blasting operation.

For asbestos abatement activities, which may be any activity which involves the removal, dislodging, stripping, encapsulating or enclosing of toxic surfacing materials containing asbestos, dry abrasive blasting operations are undesirable due to the large amount of solid waste in the form of dust which is produced by dry abrasive blasting. The waste dust produced contaminates the air within and around the work area, creating an unsafe condition for those exposed to the waste dust produced due to the potential for inhalation of airborne asbestos fibers.

Due to the risk of exposure to asbestos fibers, in particular, asbestos abatement activities are closely regulated and must be carried out in accordance with several safety regulations intended to reduce the amount of asbestos fibers introduced into the air supply during the abatement activity, thereby minimizing the exposure of workers and others to the asbestos fibers. For example, abatement activities often require, among other safeguards, isolation of the work area, creation of negative pressure environments for control and collection of solid, airborne waste produced, the use of respirators, as well as sampling and analysis of air within and near the work area to ensure that asbestos exposure remains below defined exposure limits. These safeguards serve to ensure that Permissible Exposure Limits (PELs), as defined by state and federal statutes, including Occupational Safety and Health Administration (OSHA) regulation 29 CFR §1926.1101, entitled Asbestos Standard for Construction Industry, are not exceeded. At present, OSHA defines the applicable PELs as: 0.1 fibers per cubic centimeter of exposure as an eight hour time-weighted average; and, 1.0 fiber per cubic centimeter of exposure averaged over a thirty minute period. The amount of exposure to asbestos may be determined using air quality analysis for air within or outside the work area, such as phase contrast microscopy (PCM).

Due to the health risks associated to asbestos abatement activities, and associated health and safety regulations, existing apparatuses and methods for performing abatement activities for the removal of toxic surfacing materials are largely inefficient and slow, requiring many operators and extensive preparation of the work area and clean up. A need exists for improved apparatuses and methods allowing for faster, cheaper asbestos abatement while remaining in compliance with any and all applicable health and safety regulations.

### SUMMARY

An apparatus and method for removal of toxic surfacing materials from a work surface via an abrasive blasting operation are provided herein.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 is a block diagram of a blasting apparatus;

FIG. 2 is a side view of a connector;

FIG. 3 is a side view of a discharge device; and,

FIG. 4 is a flowchart of a method of wet blasting using a blasting apparatus.

### DETAILED DESCRIPTION

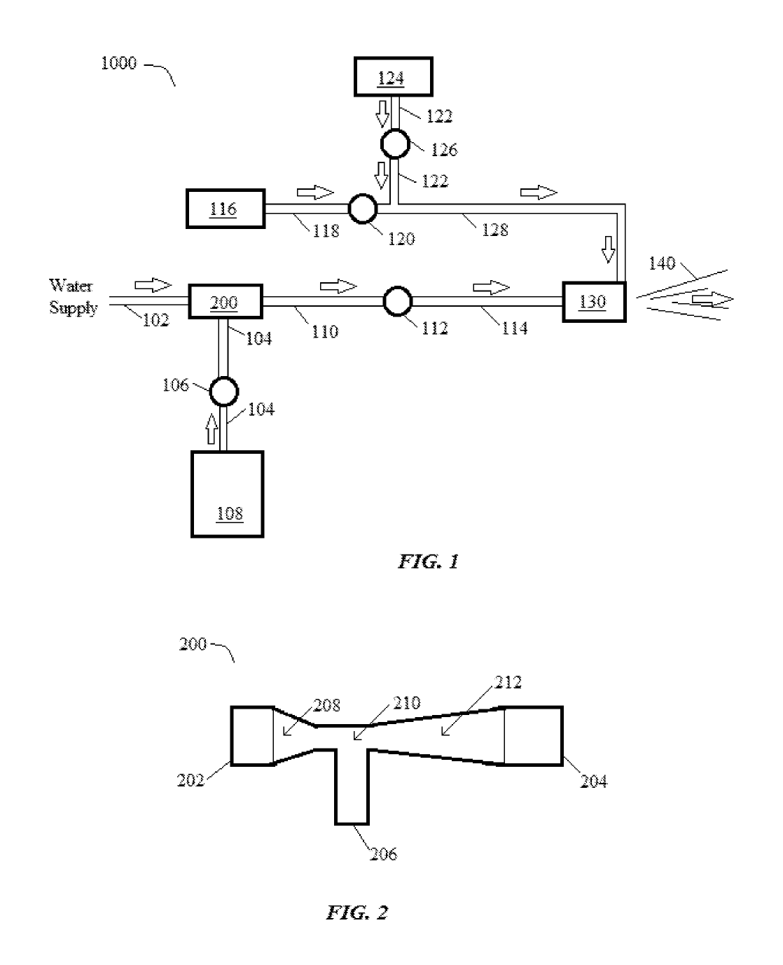

Referring to FIG. 1, an embodiment of a blasting apparatus 1000 configured to accommodate removal of one or more surface materials, including one or more toxic surfacing materials, from a work via an abrasive blasting operation is shown. In an embodiment, the blasting apparatus 1000 may comprise a component configuration capable of removal of one or more toxic surfacing materials, which may contains asbestos, from a work in compliance with any and all applicable health and safety standards, which may include, at least, the OSHA Asbestos Standard for Construction Industry, 29 CFR §1926, and the Environmental Protection Agency (EPA) National Emission Standard for Asbestos, 40 CFR Part 61, Subpart M, among others.

In such an embodiment, the blasting apparatus 1000 may be configured to accommodate a “wet” abrasive blasting operation, which may be an abrasive blasting operation in which the blast media and waste material produced remains sufficiently wet to militate against the production of waste in the form of airborne dust particles. In an embodiment, the “wet” abrasive blasting operation accommodated by the blasting apparatus 1000 may maintain the blast media as well as the waste produced in a state in which they remain sufficiently mixed or penetrated with liquid that no dry blast media or waste is present in the work area, effectively preventing the release of particulates into the local air supply in the form of waste dust. All waste produced through a “wet” abrasive blasting operation, as accommodated by the blasting apparatus 1000, may pool along the floor of the work area rather than be released into the air.

Referring to the particular embodiment shown in FIG. 1, the blasting apparatus 1000 may comprise: a plurality of conduit sections 102, 104, 110, 114, 118, 122, and 128; a connector 200; a plurality of valves 106, 112, 120, and 126; an additive supply 108; a compressor 116; an abrasive supply 124; and, a discharge device 130. In alternative embodiments, the blasting apparatus 1000 may comprise additional, fewer, or different components than those shown in FIG. 1. For example, in an alternative embodiment, the blasting apparatus 1000 may comprise additional, or fewer, conduit sections and/or valves than are shown in the embodiment of FIG. 1. Additionally, or alternatively, in an embodiment, the blasting apparatus 1000 may comprise additional components, such as filters, high pressure switches or valves, mechanical safety locking devices, and the like. Further, in alternative embodiments, the blasting apparatus 1000 may comprise a component configuration different from that shown in FIG. 1.

According to the embodiment of FIG. 1, the blasting apparatus 1000 may include the first conduit section 102 for placing a water supply in either in direct or indirect fluid communication with one or more components of the blasting apparatus 1000, such as the connector 200, for example. The first conduit section 102 may be configured to receive liquid water from a water supply. The first conduit section 102 may direct received water to the connector 200, as indicated by the arrows of FIG. 1.

In an embodiment, the first conduit section 102 may comprise a length of hose, tube, pipe, or the like and may comprise two open ends. The first conduit section 102 may comprise a plastic, metal, composite, or other material which may be suitable for receiving and routing received liquid. The first conduit section 102 may be configured to couple to a water source which may comprise a pipe, tank, reservoir, or other vessel suitable for storing a liquid. The first conduit section 102 may couple to the water source at an inlet end of the first conduit section 102. The first conduit section 102 may be configured to couple to the connector 200 at an outlet end of the first conduit section 102, whereby water received by the first conduit section 102 may be routed from the water source to the connector 200 (as indicated by the arrows shown in FIG. 1). In an embodiment, the first conduit section 102 may couple with the water source and/or the connector 200, respectively, via threaded connections disposed at each end of the first conduit section 102. Alternatively, in an embodiment, the first conduit section 102 may couple with the water source and/or the connector 200, respectively, via any known coupling means suitable for creating a substantially watertight connection, including quick disconnects, crimped connections, compression fittings, and the like.

As shown in FIG. 1, the blasting apparatus 1000 may include the second conduit section 104 for placing the additive supply 108 in either in direct or indirect fluid communication with one or more other components of the blasting apparatus 1000, such as the connector 200, for example. The second conduit section 104 may be configured to receive an additive, which may be in the liquid state, from the additive supply 108. The second conduit section 104 may direct received additive to the connector 200, as indicated by the arrows of FIG. 1.

In an embodiment, the second conduit section 104 may comprise a length of hose, tube, pipe, or the like and may comprise two open ends. The second conduit section 104 may comprise a plastic, metal, composite, or other material which may be suitable for receiving and routing received liquid. The second conduit section 104 may be configured to couple to the additive supply 108, which may comprise a pipe, tank, reservoir, or other suitable vessel for storing a liquid. The second conduit section 104 may couple to the additive supply 108 at an inlet end of the second conduit section 104. The second conduit section 104 may be configured to couple to the connector 200 at an outlet end of the second conduit section 104, whereby additive received by the second conduit section 104 may be routed from the additive supply 108 to the connector 200 (as indicated by the arrows shown in FIG. 1). In an embodiment, the second conduit section 104 may couple with the additive supply 108 and/or the connector 200, respectively, via threaded connections disposed at each end of the second conduit section 104. Alternatively, in an embodiment, the second conduit section 104 may couple with the additive supply 108 and/or the connector 200, respectively, via any known coupling means suitable for creating a substantially watertight connection, including quick disconnects, crimped connections, compression fittings, and the like.

In an embodiment, the additive stored within the additive supply 108 and directed to the connector 200 via the second conduit section 104 may comprise, at least, a surface acting agent, or surfactant. In alternative embodiments, the additive stored within the additive supply 108 may additionally comprise one or more fluids which may include rust retardants, pesticides, disinfectants, insulating or fireproofing solutions, and the like.

Surfactants may be compounds that lower the surface tension, or interfacial tension, of a liquid to which the surfactant is added, allowing the liquid to spread more easily. Importantly, surfactants may promote greater spreading of a liquid over the surface area of solid materials which the surfactant-and-liquid solution may come into contact with. In an embodiment, the additive 108 may comprise, at least, one or more surfactants of any known type which may function to decrease the surface tension of water, whereby the additive 108 may function as a wetting agent when mixed with water.

Referring to FIGS. 1 and 2, the blasting apparatus 1000 may include the connector 200 for placing a plurality of conduit sections comprising the blasting apparatus 1000 in either in direct or indirect fluid communication with one another. According to the embodiment shown, for example, the connector 200 may place the first conduit section 102, the second conduit section 104, and the third conduit section 110 in either in direct or indirect fluid communication with one another, for example. In such an embodiment, the connector 200 may function to receive one or more fluid sources, such as water from the first conduit section 102 and additive from the second conduit section 104, which may mix within the connector 200 and be directed into the third conduit section 110, as indicated by the arrows of FIG. 1.

In an embodiment, the connector 200 may comprise a section of hose, tube, pipe, or the like, which may be composed of plastic, metal, composite, or other suitable material for receiving and routing fluid flows within the blasting apparatus 1000. According to the embodiment shown in FIGS. 1 and 2, the connector 200 may comprise a “T” shaped section of material having three open ends, which may include a first inlet 202, an outlet 204, and a second inlet 206. In alternative embodiments, the connector 200 may be implemented with a shape differing from that shown in the embodiment of FIG. 2, such as a “Y” shape or “F” shape, for example. In further alternative embodiments, the connector 200 may comprise more than three open ends. In such further alternative embodiments, additional fluids may be received at the respective inlets of the connector 200, with the received fluids combining within the connector 200 and routed to the third conduit section 110.

According to the embodiment shown, the connector 200 may couple with the first conduit section 102 at the first inlet 202, the second conduit section 104 at the second inlet 206, and the third conduit section 110 at the outlet 204. Accordingly, the connector 200 may receive water and additive from the first conduit section 102 and the second conduit section 104, respectively, which may combine within the connector 200. The combined water and additive may comprise amended water. The amended water may be routed into the third connector 110 via the outlet 204 of the connector 200. Importantly, the amended water may comprise one or more fluid characteristics differing from that of the source water received at the first inlet 202. For example, the amended water may comprise a lower surface tension than that of the received source water, whereby the amended water may more readily spread over the surface, or surfaces, of one or more solid materials or particulates the amended water may come into contact with than the source water would. Accordingly, the amended water may be expected to more readily surround and coat any and all solid materials or particulates that it may come into contact with than the source water.

Referring to FIG. 2, internal features of the connector 200 are shown. In an embodiment, the connector 200 may be configured with a “back flow nozzle” configuration which may comprise a converging section 208, a throat 210, and a diverging section 212. Generally, such a configuration may be expected to induce a pressure drop across the connector 200 as fluid flows from the first inlet 202 and toward the outlet 204, and may induce fluid flow into the connector 200 via the second inlet 206 in accordance with the Venturi effect.

As shown, the converging section 208 may be disposed proximal to the first inlet end 202 and the diverging section 212 may be disposed proximal to the outlet end 206. The throat section 210 may be interposed between the converging section 208 and the diverging section 212. In an embodiment, a flow of source water, which may be stored at or pumped to a positive pressure, may flow through the connector 200 from the first inlet 202 toward the outlet 204. This flow of source water may induce a pressure drop across the connector 200, substantially at the throat 210 of the connector 200, whereby additive fluid may be sucked into the connector 200 and combine with the source water flow. According to such an embodiment, source water may be disposed within the converging section 208, while both source water and additive may be disposed within the throat section 210. The source water and additive may mix within the connector 200 at the throat section 210 and within the diverging section 212, producing amended water which may be discharged from the connector at the outlet 204 and into the third conduit section 110.

In alternative embodiments to that shown, the connector 200 may comprise a configuration differing from the “back flow nozzle” configuration shown. In such alternative embodiments, a flow of additive fluid into the connector 200 may be affected by a pump, by gravity, or by any other suitable means for causing or inducing additive to flow from the additive supply 108 into the connector 200.

Turning back to FIG. 1, in an embodiment, the blasting apparatus 1000 may include a valve 106 for controlling the flow rate of additive entering the connector 200. The valve 106 may function as a flow control valve, permitting the flow rate of additive entering the connector 200 to a desired value. According to the embodiment shown, the valve 106 may be disposed at any location along the length of the second conduit section 104, interposed between the additive supply 108 and the connector 200. In an embodiment, the valve 106 may be configured for manual setting by an operator of the blasting apparatus 1000 or, alternatively, for automatic setting. The valve 106 position may be set, or adjusted, in response to one or more conditions within the work area, such as in response to one or more air quality parameters, one or more pressures of a fluid, or fluids, within the blasting apparatus 1000, or other sensed, detected, measured, or calculated parameter value. Additionally, or alternatively, the flow rate of additive may be set, or adjusted, using the valve 106 in response to one or more parameters of the abrasive in use by the blasting apparatus 1000, such as the abrasive size or flow rate, for example.

The valve 106 may allow for the composition of the amended water to be adjustable via either increasing or decreasing the relative amount of additive comprising the resultant amended water exiting the connector 200. During operation of the blasting apparatus 1000, therefore, an operator of the blasting apparatus 1000 may configure the amended water mixture to achieve a desired level of “spreadability” of the amended water, whereby an increase in the relative amount of additive within the amended water may be expected to cause a corresponding decrease in the surface tension of the amended water, increasing the “spreadability” of the amended water.

Referring to FIG. 1, the blasting apparatus 1000 may include the third conduit section 110 for placing the connector 200 in either in direct or indirect fluid communication with one or more components of the blasting apparatus 1000, such as the valve 112, for example. In such an embodiment, the third conduit section 110 may be configured to receive amended water from the connector 200 and may direct the received amended water to the valve 112, as indicated by the arrows of FIG. 1.

In an embodiment, the third conduit section 110 may comprise a length of hose, tube, pipe, or the like and may comprise two open ends. The third conduit section 110 may comprise a plastic, metal, composite, or other material which may be suitable for receiving and routing received liquid. The third conduit section 110 may couple to the connector 200 at an inlet end of the third conduit section 110. The third conduit section 110 may be further configured to couple to the valve 112 at an outlet end of the third conduit section 110, whereby amended water may be routed from the connector 200 to the valve 112 (as indicated by the arrows shown in FIG. 1). In an embodiment, third conduit section 110 may couple with the connector 200 and the valve 112, respectively, via threaded connections disposed at each end of the third conduit section 110. Alternatively, in an embodiment, the third conduit section 110 may couple with the connector 200 and the valve 112, respectively, via any known coupling means suitable for creating a substantially watertight connection, including quick disconnects, crimped connections, compression fittings, and the like.

As shown in FIG. 1, in an embodiment, the blasting apparatus 1000 may include the valve 112 for controlling the flow rate of amended water exiting the third conduit section 110 and flowing into the fourth conduit section 114. The valve 112 may function as a flow control valve, permitting the flow rate of amended water within the blasting apparatus 1000 to be set to a desired value. According to the embodiment shown, the valve 112 may be disposed at any location along the length of the third conduit section 110, interposed between the connector 200 and the discharge device 130. In an embodiment, the valve 112 may be configured for manual setting by an operator of the blasting apparatus 1000 or, alternatively, for automatic setting. The valve 112 position may be set, or adjusted, in response to one or more conditions within the work area, such as in response to one or more air quality parameters, one or more pressures of a fluid, or fluids, within the blasting apparatus 1000, or other sensed, detected, measured, or calculated parameter value. Additionally, or alternatively, the flow rate of amended water may be set, or adjusted, using the valve 112 in response to one or more parameters of the abrasive used by the blasting apparatus 1000, such as the abrasive size or flow rate, for example.

In an embodiment, the blasting apparatus 1000 may not be implemented with the valve 112 or, alternatively, the valve 112 may comprise a feature of another component of the blasting apparatus 1000, such as the discharge device 130, for example. According to such alternative embodiments, the third conduit section may be expected to couple with, and place in either in direct or indirect fluid communication with one another, the connector 200 and the discharge device 130.

Referring to the embodiment of FIG. 1, the blasting apparatus 1000 may include the fourth conduit section 114 for placing the one or more components of the blasting apparatus 1000 in either in direct or indirect fluid communication with one another, such as the valve 112 and the discharge device 130, for example. In such an embodiment, the fourth conduit section 114 may be configured to receive amended water exiting the valve 112 and may direct the received amended water to the discharge device 130, as indicated by the arrows of FIG. 1.

In an embodiment, the fourth conduit section 114 may comprise a length of hose, tube, pipe, or the like and may comprise two open ends. The fourth conduit section 114 may comprise a plastic, metal, composite, or other material which may be suitable for receiving and routing received liquid. The fourth conduit section 114 may couple to the valve 112 at an inlet end of the fourth conduit section 114. The fourth conduit section 114 may be further configured to couple to the discharge device 130 at an outlet end of the fourth conduit section 114, whereby amended water may be routed from the valve 112 to the discharge device 130 (as indicated by the arrows shown in FIG. 1). In an embodiment, fourth conduit section 114 may couple with the valve 112 and the discharge device 130, respectively, via threaded connections disposed at each end of the fourth conduit section 114. Alternatively, in an embodiment, the fourth conduit section 114 may couple with the valve 112 and the discharge device 130, respectively, via any known coupling means suitable for creating a substantially watertight connection, including quick disconnects, crimped connections, compression fittings, and the like.

Amended water received at the discharge device 130 may be expelled from the discharge device 130, comprising a portion of a blast spray 140. The amended water may function as a containment agent of the blast spray 140, operating to spread over and saturate abrasive within the blast spray 140 as well as waste particulates which may be produced from blasting a work surface with the blast spray 140. These functions of the blasting apparatus 1000 and the amended water flowing within it are discussed in greater detail later in this specification.

As shown in FIG. 1, the blasting apparatus 1000 may include the pump 116, which may be a compressor. In an embodiment, the pump 116 may comprise a compressor of any known type which may be suitable for pressurizing air to a sufficiently high pressure, such as between 3 and 130 PSI, for example, for use in an abrasive blasting operation. In an embodiment, the pump 116 may generate high pressure air for use in propelling abrasive within the blasting apparatus 1000 as well as in forcing the blast spray 140 from the discharge device 130. The operation and control of pumps, such as compressors, are known to those of ordinary skill in the art and, thus, are omitted from this specification.

According to the embodiment of FIG. 1, the blasting apparatus 1000 may include the fifth conduit section 118 for placing the pump 116 in either in direct or indirect fluid communication with one or more components of the blasting apparatus 1000, such as the valve 120, for example. In such an embodiment, the fifth conduit section 118 may be configured to receive pressurized air from the pump 116 and may direct the received pressurized air to the valve 120, as indicated by the arrows of FIG. 1.

In an embodiment, the fifth conduit section 118 may comprise a length of hose, tube, pipe, or the like. The fifth conduit section 118 may comprise a plastic, metal, composite, or other material which may be suitable for receiving and routing fluids at high pressures. The fifth conduit section 118 may comprise two open ends. The fifth conduit section 118 may couple to the pump 116 at an inlet end of the fifth conduit section 118. The fifth conduit section 118 may be further configured to couple to the valve 120 at an outlet end of the fifth conduit section 118, whereby pressurized air may be routed from the pump 116 to the valve 120 (as indicated by the arrows shown in FIG. 1). In an embodiment, the fifth conduit section 118 may couple with the pump 116 and the valve 120, respectively, via quick disconnect connections which may be disposed the ends of the fifth conduit section 118. Alternatively, in an embodiment, the fifth conduit section 118 may couple with the pump 116 and/or the valve 120, respectively, via any known coupling means suitable for creating a substantially airtight connection, including threaded connections, crimped connections, compression fittings, and the like.

As shown in FIG. 1, in an embodiment, the blasting apparatus 1000 may include the valve 120 for controlling the flow rate of pressurized air through the fifth conduit section 118. The valve 120 may function as a flow control valve, permitting the flow rate of pressurized air within the blasting apparatus 1000 to be set to a desired value. According to the embodiment shown, the valve 120 may be disposed substantially at the outlet of the fifth conduit section 118. In an embodiment, the valve 120 may be a flow control valve of any type and/or configuration suitable for use with the pump 116 to regulate the pressure of air. The valve 120 may be configured for manual setting by an operator of the blasting apparatus 1000 or, alternatively, for automatic setting. The valve 120 position may be set, or adjusted, in response to one or more conditions within the work area, such as in response to one or more air quality parameters, one or more pressures of a fluid, or fluids, within the blasting apparatus 1000, or other sensed, detected, measured, or calculated parameter value. Additionally, or alternatively, the pressure setting may be set, or adjusted, using the valve 120 in response to one or more parameters of the abrasive used by the blasting apparatus 1000, such as the abrasive size, composition, flow rate, or the like.

In an embodiment, the blasting apparatus 1000 may not be implemented with the valve 120 or, alternatively, the valve 120 may comprise a feature of another component of the blasting apparatus 1000, such as the pump 116, for example. According to such alternative embodiments, the fifth conduit section 118 may be expected to couple with, and place in either in direct or indirect fluid communication with one another, the pump 116 and the discharge device 130.

According to the embodiment of FIG. 1, the blasting apparatus 1000 may include the sixth conduit section 122 for connecting the abrasive supply 124 with one or more components of the blasting apparatus 1000, such as the valve 126, for example. In such an embodiment, the sixth conduit section 122 may be configured to receive abrasive from the abrasive supply 124 and may direct the received abrasive to the valve 126, as indicated by the arrows of FIG. 1.

In an embodiment, the sixth conduit section 122 may comprise a length of hose, tube, pipe, or the like. The sixth conduit section 122 may comprise a plastic, metal, composite, or other material which may be suitable for receiving and routing abrasive, which may be in the form of very small particles of solid material. The sixth conduit section 122 may comprise two open ends. The sixth conduit section 122 may couple to the abrasive supply 124, which may comprise a length of pipe, a tank, reservoir, funnel or other suitable vessel for storing a solid material in small particle form, at an inlet end of the sixth conduit section 122. The sixth conduit section 122 may be further configured to couple to the valve 126 at an outlet end of the sixth conduit section 122, whereby abrasive may be routed from the abrasive supply 124 to the valve 126 (as indicated by the arrows shown in FIG. 1). In an embodiment, the sixth conduit section 122 may couple with the abrasive supply 124 and the valve 126, respectively, via quick disconnect connections which may be disposed the ends of the sixth conduit section 122. Alternatively, in an embodiment, the sixth conduit section 122 may couple with the abrasive supply 124 and/or the valve 126, respectively, via any known coupling means, including threaded connections, crimped connections, compression fittings, and the like.

In an embodiment, the abrasive stored within the abrasive supply 124 and directed to the valve 126 via the sixth conduit section 122 may comprise solid particles of between 20 to 350 Mesh sizes. In an embodiment, the abrasive may comprise garnet. In alternative embodiments, the abrasive stored within the abrasive supply 124 may comprise silica sand, magnesium sulfate, aluminum oxide, crushed glass grit, silicon carbide, plastic, pumice, steel shot or grit, baking soda, dry ice, or any other abrasive which may be suitable for use in blasting operations.

As shown in FIG. 1, in an embodiment, the blasting apparatus 1000 may include the valve 126 for controlling the flow rate of abrasive through the sixth conduit section 122. The valve 126 may function as a flow control valve, permitting the flow rate of abrasive within the blasting apparatus 1000 to be set to a desired value. According to the embodiment shown, the valve 126 may be disposed at any point along the length of the sixth conduit section 122. In an embodiment, the valve 126 may be a flow control valve of any type and/or configuration suitable for use with the abrasive supply 124 to regulate the rate at which abrasive is supplied to other components of the blasting apparatus 1000, such as the seventh conduit section 128 and/or the discharge device 130. The valve 126 may be configured for manual setting by an operator of the blasting apparatus 1000 or, alternatively, for automatic setting.

The valve 126 position may be set, or adjusted, in response to one or more conditions within the work area, such as in response to one or more air quality parameters, one or more pressures of a fluid, or fluids, within the blasting apparatus 1000, or other sensed, detected, measured, or calculated parameter value. Additionally, or alternatively, the pressure setting may be set, or adjusted, using the valve 126 in response to one or more parameters of the abrasive used by the blasting apparatus 1000, such as the abrasive size, composition, flow rate, or the like.

In an embodiment, the blasting apparatus 1000 may not be implemented with the valve 126 or, alternatively, the valve 126 may comprise a feature of another component of the blasting apparatus 1000, such as the discharge device 130, for example. According to such alternative embodiments, the sixth conduit section 122 may be expected to couple with, and place in either in direct or indirect fluid communication with one another, the abrasive supply 124 and the discharge device 130.

Referring to FIG. 1, the blasting apparatus 1000 may include the seventh conduit section 128 for placing the pump 116 and the abrasive supply 124 either in direct or indirect fluid communication with one or more components of the blasting apparatus 1000, such as the discharge device 130, for example. In such an embodiment, the seventh conduit section 128 may be configured to receive pressurized air from the pump 116 via the fifth conduit section 118 as well as abrasive from the abrasive supply 124 via the sixth conduit section 122. The seventh conduit section 128 may direct the received pressurized air and abrasive to the discharge device 130, as indicated by the arrows of FIG. 1.

In an embodiment, the seventh conduit section 128 may comprise a length of hose, tube, pipe, or the like and may comprise one or more inlets and an outlet. The seventh conduit section 128 may comprise a plastic, metal, composite, or other material which may be suitable for receiving and routing the received mix of pressurized air and abrasive. The seventh conduit section 128 may couple to the valve 120 and the sixth conduit section 122, respectively, at inlets of the seventh conduit section 128. Further, the seventh conduit section 128 may couple to the discharge device 130 at an outlet of the seventh conduit section 128. Accordingly, a mix of pressurized air and abrasive may be received by the seventh conduit section 128 and may be routed to the discharge device 130 (as indicated by the arrows shown in FIG. 1). In an embodiment, seventh conduit section 128 may couple with the valve 120, the sixth conduit section 122, and the discharge device 130, respectively, via threaded connections. Alternatively, in an embodiment, the seventh conduit section 128 may couple with the valve 120, the sixth conduit section 122, and the discharge device 130, respectively, via any known coupling means suitable for creating substantially airtight connections, including quick disconnects, crimped connections, compression fittings, and the like.

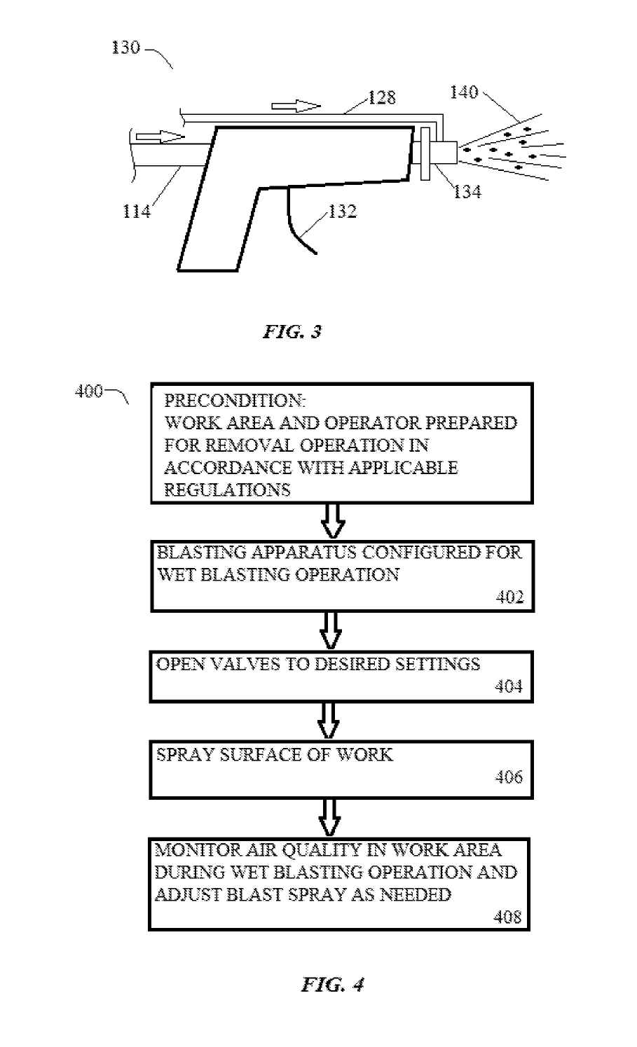

Referring to FIGS. 1 and 3, the blasting apparatus 1000 may include the discharge device 130 for generating, controlling, and directing the blast spray 140. According to the embodiment shown, the discharge device 130 may be configured to be in fluid communication with both of the fourth conduit section 114 and the seventh conduit section 128, respectively, for receiving amended water, compressed air, and abrasive, respectively. In an embodiment, the discharge device 130 may be configured for use by a single operator and may comprise, generally, a pistol shaped component implemented with a trigger 132 and a nozzle 134. Further, in an embodiment, the discharge apparatus 130 may comprise, specifically, an IBIX brand HELIX Blast Gun and nozzle or, alternatively, a device having similar construction, features, and functions to those of the IBIX brand HELIX Blast Gun and nozzle, as described herein.

In an embodiment, the discharge device 130 may comprise a component configuration for combining the received amended water, compressed air, and abrasive to generate the blast spray 140 for use in “wet” abrasive blasting operations. The received amended water and the received mixture of compressed air and abrasive may combine substantially within the nozzle 134 of the discharge device 130. The discharge device 130 may be configured to generate and expel the blast spray 140 from the nozzle 134 of the discharge device 130 at times when operator input is received from at the trigger 132 of the discharge device 130.

Importantly, the blast spray 140 generated may comprise low surface tension, due to the use of surfactant within the amended water, allowing for greater surface contact between the amended water and solid materials with which the amended water may come into contact. The blast spray 140 may exit the nozzle 134 as a vapor mist within which the abrasive media is contained. As such, the abrasive may be substantially surrounded by, and saturated with, amended water which may comprise a fine mist or vapor. The blast spray 140 may be directed by an operator of the blasting apparatus 1000 toward a work surface for removing one or more surfacing materials from the work surface. The surfacing material, whether toxic or non-toxic, may be dislodged from and removed from the work surface, with the abrasive media and dislodged surfacing material substantially surrounded and saturated by the amended water mist of the blast spray 140.

The blasting apparatus 1000 may be used in accordance with the method 400, shown in FIG. 4, to safely remove toxic or non-toxic surfacing materials from one or more work surfaces, as described below. Such operation may be described as a wet blasting operation and may comply with any and all applicable health and safety regulations, to include, at least, those contained within 29 CFR §1926.1101, the OSHA Asbestos Standard for Construction Industry. The blasting apparatus 1000 may comply with the applicable standards, in part, due to the blasting apparatus 1000 configuration which may accommodate an abrasive blasting operation within a sufficiently wet environment. Specifically, the use of amended water within the blast spray may prevent, or greatly reduce, the creation of waste in the form of dust since the amended water portion of the blast spray may be expected to substantially surround, and saturate, the surfacing material waste generated by the wet blasting operation. Further, exposure levels for those in the work area may be expected to remain within permissible levels, such as within the PELs defined in 29 CFR §1926.1101.

Referring to FIG. 4, as a precondition to the commencement of wet blasting operation, the work area and all operators may be prepared in compliance with any and all applicable health and safety regulations. Preparations may include: performing an initial assessment of anticipated PELs, as required; isolation of the work area from the surroundings, as required; construction of a negative pressure environment enclosing the work area, as required; placement of warning signs and labels in and around the work area, as required; donning of personal protective equipment by operator which may include an air purifying respirator, protective clothing, hard hat, and/or safety glasses, as proscribed by applicable health and safety regulations; and, placement of one or more devices for periodic or continuous sensing, measuring, detecting, and/or calculating one or more air quality parameters, as required.

At the step 402, the blasting apparatus 1000 may be configured for use as part of a wet blasting operation. Configuration of the blasting apparatus 1000 may comprise connecting the blasting apparatus to a water supply, to a surfactant supply, and to a blast media supply as described, above, and as shown in FIGS. 1-3.

At the step 404, one or more valves of the blasting apparatus 1000 may be set to desired initial settings to configure the blast spray to be generated using the blasting apparatus 1000. In an embodiment, each of the valves 106, 112 may be set to configure the relative composition of the amended water portion comprising the blast spray. Additionally, the valves 120, 126 may be set to provide the blast spray with the desired amount of abrasive as well as to set the pressure value for compressed air to be utilized by the blasting apparatus 1000. Additionally, at the step 404, the pump 116 may be energized.

At the step 406, an operator may begin wet blasting one or more work surfaces to remove the surfacing materials. The wet blasting operation may generate waste materials as surfacing material, or materials, are dislodged from the work surface. In instances where the waste materials may be toxic, one or more air quality parameters in and around the work area may be monitored using known, or proscribed, methods. For example, in an asbestos abatement operation, air quality in and around the work area may be monitored, or checked, through use of phase contrast microscopy to ensure that PELs, as defined in any and all applicable health and safety standards are not exceeded.

As needed, at the step 408, one or more configuration parameters of the blasting apparatus 1000, such as the positions of one or more valves, may be adjusted in response to results air quality monitoring. For example, if air monitoring reveals that exposure levels in and around a work area during a wet blasting operation to remove asbestos from a work surface are approaching, or exceed, a defined PEL, the operator may respond by opening the valve 106 to increase the surfactant within the amended water supply. This may further decrease the surface tension of the amended water within the blast spray, promoting greater saturation of any and all waste produced by the wet blasting operation, thereby reducing or eliminating any waste dust generated. Additionally, or alternatively, the operator may decrease either or both of the abrasive supply via the valve 126, or the air pressure via the valve 120 to decrease the relative amount of abrasive forming the blast spray.

If no unsafe condition is found at the step 408, the operator may continue wet blasting operation in the current configuration until the abatement activity is completed. Alternatively, if no unsafe condition is found at the step 408, the operator may return to the step 406 and continue wet blasting operation in the current configuration for a predetermined amount of time before returning to the step 408 to again check the air quality within an around the work area. In an embodiment, the amount of time may be thirty minutes or, alternatively, an amount of time proscribed by an applicable health or safety regulation.

Advantageously, asbestos abatement using the blasting apparatus 1000 and in accordance with the method 400 may provide the advantages of providing for rapid asbestos abatement while avoiding production of airborne waste within and around the work area. Further, the apparatus and method described, herein, may provide for a wet blasting method of asbestos removal in which the wetting agent as well as the abrasive may be delivered to the work surface via a single discharge device operated by a single operator. The apparatus and method described, herein, may also provide for easier clean up following an asbestos abatement activity since the waste produced comprises a liquid waste product comprising removed surfacing material and abrasive substantially saturated with amended water rather than solid waste product in the form of surfacing material dust.

In an exemplary execution of the method 400, for example, an embodiment of the blasting apparatus 1000 described above may be utilized in a wet blasting operation to remove residual fireproofing, containing asbestos, as well as glue form a corrugated ceiling deck in compliance with the regulations of 29 CFR §1926.1101. As a precondition to the commencement of wet blasting, the work area and operators may be prepared in compliance with all applicable regulations, including the work area being isolated from the surroundings by plastic membranes, creation of a negative pressure environment within the work area in which air from the work area may be forced through HEPA filters, and donning of respirators and protective clothing by the operators.

The blasting apparatus 1000, which may comprise an IBIX 25 H₂O Blasting System, may be connected to a water source via a hose. The blasting apparatus 1000 may be implemented with a Venturi style connector and a flow control valve which may be placed in fluid communication with the water supply. The connector may access a surfactant supply and may be configured to induce flow of surfactant into the connector while source water is flowing through the connector to produce amended water.

The blasting apparatus 1000 may be implemented with an IBIX HELIX Blast Gun and a 7/32″ nozzle. A compressor may be operatively connected to an abrasive supply, which may comprise garnet, and also operatively connected to the Blast Gun to deliver the abrasive and compressed air to the Blast Gun.

The water source and Venturi may be configured to supply amended water to the Blast Gun at 1.5 gallons/hour through setting of flow control valves. The abrasive media supplied to the Blast Gun may be set to a rate of 110 pounds per hour through setting of flow control valves. A single operator may operate the Blast Gun to direct the resultant blast spray at the corrugated ceiling to remove the residual fireproofing and glue. During blasting operation, the air quality and exposure levels of operators within the work zone, as well as in the surrounding areas, may be monitored in accordance with the PCM method with samples taken after thirty minutes of blasting and after approximately eight hours of blasting.

According to such an exemplary operation, the wet blasting operation may yield a production rate well above that other methods, such as grinding, while not exposing the operator to asbestos fibers at above the PELs defined by 29 CFR §1926.1101. Details of such an exemplary execution of the method 400 using an embodiment of the blasting apparatus 1000 are documented and provided as Appendices A-C of this specification.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of other features. Many such variations and modifications may be considered desirable by those skilled in the art based upon a review of the foregoing description of preferred embodiments.

1. A blasting system for the removal of asbestos, comprising:
a discharge device for controlling the delivery of a blast spray via a nozzle of the discharge device to a surface of a work to remove one or more surfacing materials containing asbestos from the work;
wherein the discharge device is operable by a single operator to deliver the blast spray, the blast spray comprising:
a first fluid comprising a mixture of water and an additive, wherein the first fluid comprises a surface tension less than that of water and exits the nozzle as a liquid vapor; and
an abrasive comprising particles of solid material;
wherein the first fluid substantially surrounds the solid abrasive particles exiting the nozzle; and,
wherein the one or more surface materials removed from the work are substantially surrounded, and saturated by, the first fluid.

2. The blasting system of claim 1, wherein the additive comprises a surfactant.

3. The blasting system of claim 1, wherein the abrasive comprises garnet.

4. The blasting system of claim 1, further comprising a connector placing a water source in fluid communication with an additive source, wherein water from the water source combines with additive from the additive source within the connector to produce the first fluid.

5. The blasting system of claim 4, wherein the connector comprises a configuration capable of inducing a flow of additive into the connector in response to water from the water source flowing through the connector.

6. The blasting system of claim 5, wherein the blasting system further comprises a first valve interposed between the additive supply and the connector for at least partially controlling the flowrate of additive into the connector.

7. A method for removing one or more surfacing materials containing asbestos from a work, the method comprising:
operatively coupling a discharge device to be in fluid communication with a water supply and an additive supply via at least a first conduit;
operatively coupling a discharge device to be in fluid communication with an abrasive supply via at least a second conduit;
wherein the discharge device is configured to receive a first fluid comprising a liquid mixture of water from the water supply and an additive from the additive supply via, at least, the first conduit in response to the opening of at least one first valve and wherein the discharge device is configured to receive a solid abrasive from the abrasive supply via, at least, the second conduit in response to the opening of at least one second valve;
wherein the first fluid and abrasive combine substantially at a nozzle of the discharge device to produce a blast spray for removing one or more surfacing materials from a work surface, the blast spray comprising the first fluid comprising a liquid vapor having a surface tension less than that of water and the solid abrasive;
spraying one or more surfaces of the work to remove the one or more surfacing materials containing asbestos from the work; and,
wherein the first fluid substantially surrounds the solid abrasive particles of the blast spray, and wherein the one or more surface materials removed from the work comprise solid particles substantially surrounded, and saturated by, the first fluid of the blast spray.

8. The method of claim 7, wherein the additive comprises a surfactant.

9. The method of claim 7, wherein the abrasive comprises garnet.

10. The method of claim 7, further comprising a connector disposed along the first conduit for placing the water source in fluid communication with the additive source, wherein water from the water source combines with additive from the additive source within the connector to produce the first fluid.

11. The method of claim 10, wherein the connector comprises a configuration capable of inducing a flow of the additive into the connector in response to the water from the water source flowing through the connector.

12. The method of claim 11, wherein the at least one first valve is interposed between the additive supply and the connector for at least partially controlling the flowrate of the additive into the connector.

13. The method of claim 7, further comprising:
monitoring the air proximal to the work to measure the amount of contaminant within the air proximal to the work.

14. The method of claim 13, wherein the contaminant measured is the number of asbestos fibers per cubic centimeter within the air proximal to the work.

15. The method of claim 14, wherein the amount of contaminant within the air proximal to the work is determined using phase contrast microscopy.

16. The method of claim 13, further comprising:
repositioning one or more the first and second valve in response to the determined amount of contaminant within the air proximal to the work to maintain the amount of contaminant within the air proximal to the work at or below one or more permissible levels.

17. The method of claim 16, wherein the contaminant measured is the number of asbestos fibers per cubic centimeter within the air proximal to the work, and wherein the permissible level of contaminant is 0.1 fibers per cubic centimeter of exposure as an eight hour time-weighted average.

18. The method of claim 16, wherein the contaminant measured is the number of asbestos fibers per cubic centimeter within the air proximal to the work, and wherein the permissible level of contaminant is 1.0 fiber per cubic centimeter of exposure averaged over a thirty minute period.
